(19) United States
(12) Patent Application Publication
(10) Pub. No.: US 2022/0032422 A1
(43) Pub. Date: Feb. 3, 2022

(54) Hand-Held Extender For A Buffing Pad

(71) Applicant: Buff and Shine Manufacturing, Inc., Rancho Domnguez, CA (US)

(72) Inventor: Richard Umbrell, Rancho Dominguez, CA (US)

(21) Appl. No.: 16/984,028

(22) Filed: Aug. 3, 2020

(51) Int. Cl. B24B 41/047; B24D 13/14

(52) U.S. Cl. CPC B24B 41/047; B24D 13/14

(57) ABSTRACT

An extender for a buffing pad assembly having a first portion configured to be rotated, thereby transferring power from a power tool to a buffing pad, and a second portion that can be held by a user to support, direct, and/or control the buffing pad during operation of the power tool. The extender preferably includes a shaft, a sleeve, and at least one retainer for fixing the sleeve onto the shaft. The shaft preferably includes a first portion near a first end, a second portion near a second end, and a third circular portion located therebetween. In one embodiment, the shaft includes first and second grooves, thereby allowing a first retainer (e.g., C-clip) to be snapped into the first groove, the sleeve slid over the open end of the shaft, and a second retainer (e.g., C-clip) snapped into the second groove, resulting in a fully assembled extender.

### BACKGROUND OF THE INVENTION

### 1. Field of the Invention

The present invention is directed toward an extender for connecting a buffing pad with a power tool (e.g., power buffer), and more particularly, to an extender having a sleeve that can be gripped by a user (e.g., the user's hands) to support, direct, and/or control the buffing pad during operation of the power tool.

### 2. Description of Related Art

Buffing refers to the application of a chemical or compound to a surface using a buffing pad. In the automotive detailing industry, for example, buffing is used to repair, refinish or polish the exterior surfaces of automobiles. Buffing can be done by hand, however, professionals and consumers alike prefer to use buffing pads with power buffers. A power buffer can be pneumatic, in which the power is supplied by an air compressor, or motorized, in which the power is supplied by an electric motor. A motorized power buffer is a hand-held tool having a buffing pad attached to a spindle that extends from the electric motor. The motor spins the buffing pad and thus results in faster performance, while reducing fatigue on the operator. It also allows the operator to get optimum finishing effects as compared to buffing by hand.

There are two types of motorized power buffers, including high-speed rotary buffers and dual-action or random orbital buffers. The main difference between the two relates to the direction of the rotation of the buffing pad assembly, which in turn produces different results. High-speed buffers provide a circular motion, spinning at very high continuous revolutions per minute (RPMs) and can have either one or two buffing pads attached to the motor. For example, a dual-head buffer is a high-speed rotary buffer having two buffing pads attached to the motor, adjacent to each other. Dual-action or random-orbital buffers turn in a combined circular and orbital motion, at varying speeds. The continuous revolutions of either type of buffer causes friction on contact with the surface producing heat, that when combined with a compound alters the surface of the automobile. Power buffers are used for various purposes, including repairing damages to surfaces or for different finishing effects. The buffing pads are usually circular, are made in varying sizes, and are made of various materials, such as natural wool, synthetic fibers, a blend of wool and synthetic fibers or open or closed cell synthetic foam.

Because the power buffer spins the buffing pad at a high rotational rate, the type of motion, whether it be circular, orbital or both, is integral to the desired polishing and/or waxing effect. Consequently, effective performance of the power buffer relates to the interaction between the compound, the buffing pad and the power buffer, and more particularly the connection between the buffing pad assembly and the power buffer, which directly effects the rotation. If any one of these fail, the results will be less than desirable. An uneven application of the compound can cause unsightly swirls on the surface that can only be removed by a polisher and not by hand, if at all. Certain compounds and pads, e.g., wool pads, are inherently designed to cut into the paint to repair damages. An uneven application or a faulty assembly can cause the wool pad to chip away at the surface and cause more damage. Thus, a proper connection between the buffing pad and the power buffer is critical to achieving desired results.

There are four known ways to affix the buffing pad to the spindle of the power buffer. A first way is to affix the buffing pad to a backing plate using a bolt. The backing plate has a round, non-threaded center hole that is sized to slide over the spindle. The buffing pad also has a center hole that is aligned with the center hole of the backing plate when the buffing pad is placed on the backing plate, with the threaded end of the spindle extending though both center holes. A metal nut is used to engage the threaded end of the spindle and affix the buffing pad and backing plate to the spindle. High-speed buffers typically have a lock button for the spindle shaft that prevents the spindle from rotating. Hence, with the spindle shaft locked, it is relatively easy to manually tighten the nut to affix the buffing pad and backing plate to the spindle, as well as to manually loosen the nut to remove the buffing pad and backing plate from the spindle.

A second attachment method is to affix the buffing pad to the backing plate uses a hook and loop (e.g., Velcro®) fastener. The backing plate is provided with a threaded metal socket molded into the back surface and hook material attached to the front surface. The threaded metal socket enables the backing plate to be screwed directly onto the threaded end of the spindle shaft. The buffing pad has loop material attached to its back surface, enabling the buffing pad to be affixed to the backing plate by simply pressing the buffing pad and the backing plate together. The hook and loop attachment facilitates ease of attachment to and removal of the buffing pad from the backing plate.

A third type of attachment method includes an adapter having a socket with female threads at one end and male threads at the other end. The female threads enables the adapter to be threaded onto the spindle. The male threads attach to a plastic plate that is typically sandwiched between two buffing pads bonded back-to-back. The plate includes a central socket having threads that engage the male end of the adapter. The adapter remains attached to the spindle, and the buffing pad is attached to the adapter by screwing the entire buffing pad assembly onto the male end of the adapter. When the buffing pad surface becomes spent, the entire pad assembly is unscrewed and either flipped over or replaced entirely.

A fourth attachment method includes an adapter or connector that provides a quick release mechanism. Such a quick release mechanism is advantageous in that it allows the pad to be easily detached from the power buffer and flipped over (or replaced) without requiring any special tools. This saves time and enables the operator to continue working with minimal interruption. The commercially known type of quick release mechanism connects the buffing pad assembly to the power buffer using a cylindrical shaped metal connector. One end of the connector has a threaded bore that engages the spindle of the power buffer. The other end has a hexagonal shaped head that engages a correspondingly shaped socket formed at the center of the central plate. The head further includes a plurality of protruding balls that snap into a recess formed in the socket to thereby provide a firm connection between the power buffer and buffing pad. The connector includes a release mechanism that causes the protruding balls to retract in order to facilitate removal of the buffing pad from the connector head.

Regardless of how the buffing pad is connected to the power buffer, in order to reach a certain surface or provide a greater field of vision, it may be necessary to extend the buffing pad from the power buffer. This is traditionally accomplished using an extender, which come in varying lengths (e.g., 1 inch, 2 inch, 4 inch, etc.), where a first end is connected to the buffing pad and a second end is connected to the power buffer. The type of extender used may depend on certain factors, including the length of extension needed, the type of connection on the buffing pad, and the type of connection on the power buffer. There are drawbacks, however, to using an extender. For example, the relatively long distance between the buffer and the pad can be disorienting for the operator that is already accustomed to a certain shorter distance. This tends to further exacerbate operator fatigue and results in an uneven application to the automotive surface.

Thus, in order to address these drawbacks, it would be beneficial if the user could use their free hand (i.e., the hand that is not being used to operate the power buffer) to guide the extender, and therefore the buffing pad, during operation of the power buffer. In other words, a need exists for an extender that includes both a rotating portion that transfers rotational power from the power buffer to the buffing pad and a non-rotating portion that can be grabbed by the user's hand, thereby allowing the user to support, position, and/or control the buffing pad during operation of the power buffer.

### SUMMARY OF THE INVENTION

The present invention provides an extender that overcomes the aforementioned drawbacks in the prior art. In preferred embodiments of the present invention, the extender includes a rotating portion that allows rotational power to be transferred from a power tool to a buffing pad, and a non-rotating portion that can be held by a user to support, direct, and/or control the buffing pad during operation of the power tool.

In one embodiment of the present invention, the extender includes a shaft (e.g., a metal shaft, etc.), a sleeve (e.g., a plastic sleeve, etc.), and at least one retainer (e.g., C-clip, etc.). The purpose of the retainers is to fix the sleeve (longitudinally) onto the shaft so that it does not interfere with rotational operation of the buffing pad and/or power tool. The shaft preferably includes a first end and a second end, where the first end includes a plurality of threads (e.g., male, female) configured to mate with a power tool and the second end includes a plurality of threads (e.g., male, female) configured to mate with a buffing pad. It should be appreciated that other embodiments are within the spirit and scope of the present invention. For example, the first end may have a quick-release connector and be configured to mate with a buffing pad (or other surface preparation device), and the second end may be configured to mate with a power tool (or other rotational device).

In one embodiment of the present invention, the shaft portion includes a first portion near (or adjacent) the first end, a second portion near (or adjacent) the second end, and a third portion located therebetween, where the third portion is where the sleeve will ultimately reside (at least in a preferred embodiment). This portion is preferably circular (at least substantially) and is bound by the two retainers. In one embodiment, the shaft includes two grooves (or recesses) that are configured to receive corresponding retainers (e.g., C-clips). This would allow a first retainer to mated with (e.g., snapped over) a corresponding groove on the shaft. The sleeve can then be slid over the first or third portion of the sleeve (depending on which end is open), and onto the second portion, where the sleeve will reside. The other retainer can then be attached, resulting in a fully assembled extender.

In other embodiments of the present invention, the shaft further comprises opposing flat surfaces (e.g., surfaces that are parallel to one another) that can be gripped (e.g., with a wrench) when mating the extender with (or removing it from) the power tool or buffing pad. For example, while a user may be able (e.g., with their hands) to begin threading the extender onto male/female threads of the buffing pad and male/female threads of the power tool, a wrench may be need to complete the threading (e.g., to ensure snug, secure connections). In one embodiment, the flat surfaces are on the second portion of the shaft. In other embodiment, the flat surfaces are on the first or third portions of the shaft.

As discussed above, the outer surface of the sleeve is configured to be gripped by the user's hand. Thus, it is preferred that its circumference is greater than the circumference of the retainers. This is because the retainers (along with the shaft) may rotate when the power tool is operated, whereas the sleeve should not (at least when it is secured by the user). Thus, to prevent the user's hand from contacting (or being injured by) the retainers, their outer circumferences (or diameters) should preferably be less than the outer circumference (or diameter) of the sleeve. The outer surface of the sleeve should also be designed so that it can easily be gripped by the user. For example, the outer surface may be non-circular, or include a plurality of flat surfaces, making it easier for the user to grip and prevent rotation of the sleeve.

In alternate embodiments, the shaft could be machined at a first end (or a second end) to include a portion that has a greater circumference (or diameter) than the second portion of the shaft, thereby creating a lip (or shoulder) that can function as a retainer for the sleeve. This would allow the sleeve to be slid over the open end of the shaft and onto the second portion until it comes into contacts with the lip/shoulder. A retainer (e.g., C-clip) could then be attached to the shaft (at the open end), thereby securing the sleeve between the retainer (e.g., C-clip) and the lip/shoulder.

A more complete understanding of an extender for a buffing pad assembly will be afforded to those skilled in the art, as well as a realization of additional advantages and objects thereof, by a consideration of the following detailed description of the preferred embodiment. Reference will be made to the appended sheets of drawings that will first be described briefly.

### BRIEF DESCRIPTION OF THE DRAWINGS

FIG. 1 depicts a prior art buffing pad assembly, where a buffing pad is connected directly to a power tool (e.g., via male and female threads);

FIGS. 2, 3A, and 3B illustrate an extender in accordance with one embodiment of the present invention that includes a shaft, sleeve, and first and second clips for securing the sleeve onto the shaft;

FIGS. 4A and 4B show the extender (e.g., as shown in FIG. 2) being used to connect a buffing pad to a power tool, or a rotatable spindle portion thereof;

FIGS. 5A and 5B illustrate the shaft portion of the extender (see, e.g., FIG. 2) in accordance with one embodiment of the present invention;

FIG. 6 illustrates the clip portions of the extender (see, e.g., FIG. 2) in accordance with one embodiment of the present invention;

FIGS. 7A and 7B show the clips illustrated FIG. 6 on the shaft illustrated in FIGS. 5A and 5B;

FIG. 8 illustrates the sleeve portion of the extender (see, e.g., FIG. 2) in accordance with one embodiment of the present invention;

FIG. 9 shows the shaft, clip, and sleeve portions of the extender (see FIGS. 5A, 5B, 6, and 8) assembled in accordance with one embodiment of the present invention;

FIGS. 10A and 10B illustrate a shaft portion in accordance with a first embodiment of the present invention, where opposing flat surfaces (e.g., for a wrench) are at a first end of the shaft;

FIGS. 11A and 11B illustrate a shaft portion in accordance with a second embodiment of the present invention, where opposing flat surfaces (e.g., for a wrench) are between first and second ends of the shaft;

FIG. 12 illustrates a retainer portion in accordance with one embodiment of the present invention;

FIG. 13 illustrates another embodiment of the extender where the sleeve portion has a diameter (or circumference) that is larger than a diameter (or circumference) of the clips, which may rotate during operation of the power tool;

FIGS. 14A and 14B illustrate a sleeve portion in accordance with one embodiment of the present invention;

FIGS. 15A, 15B, 15C, and 15D illustrate sleeve portion in accordance with other embodiments of the present invention;

FIGS. 16A and 16B illustrate a sleeve portion in accordance with yet another embodiment of the present invention, where the outer surface of the sleeve has a texture (e.g., raised bumps, etc.) making it easier to be gripped by a user's hand;

FIGS. 17A and 17B illustrate a shaft portion in accordance with alternate embodiments of the present invention;

FIGS. 18A and 18B illustrate a different shaft portion, or first end thereof (e.g., a quick-release connector in both a locked and unlocked position) for mating the extender with a buffing pad and/or power tool;

FIGS. 19A and 19B show an extender in accordance with another embodiment of the present invention being used to connect a buffing pad to a power tool, or a rotatable spindle portion thereof; and

FIG. 20 shows an extender in accordance with yet another embodiment of the present invention being used.

### DETAILED DESCRIPTION OF THE PREFERRED EMBODIMENT

The present invention provides an extender that includes a rotating portion, allowing for rotational power to be transferred from a power tool to a buffing pad, and a non-rotating portion that can be held by a user to support, direct, and/or control the buffing pad during operation of the power tool. This invention addresses problems found in traditional extenders, which include, but are not limited to, operator fatigue and uneven application of a buffing compound. In the detailed description that follows, like element numerals are used to describe like elements shown in one or more of the figures.

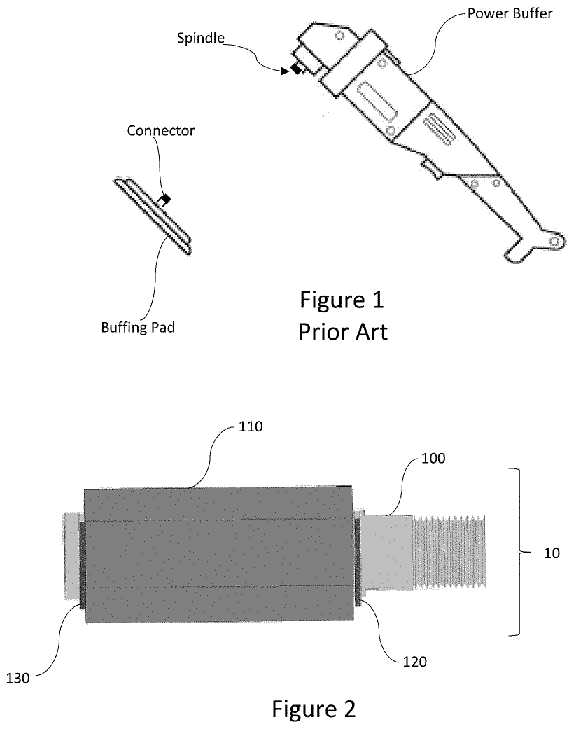

FIG. 1 provides an exploded view of a prior art buffing pad assembly comprising a power buffer and a buffing pad. The power buffer includes a handle that is carried by an operator and used to hold the buffing pad in relation to a surface. The body of the power buffer includes a motor that rotatably drives a spindle (e.g., with male threads). The power buffer will typically include a trigger switch that enables the operator to control the speed of operation of the motor. The buffing pad is attached to the spindle via a connector (e.g., with female threads). The power buffer motor spins the attached buffing pad at a very high speed in varying motions, such as circular, orbital or both, in order to get optimal polishing or refinishing effects. The male/female threads allow the operator to release (or remove) the buffing pad from the power buffer to either replace or flip to the opposite side (i.e., if it is a dual-sided buffing pad).

As discussed above, it would be advantageous to have an extender that displaces the buffing pad from the power buffer (e.g., by a predetermined length) while overcoming drawbacks associated with traditional extenders. With that being said, it should be appreciated that the present invention is not limited to such use (e.g., with power buffers and buffing pads), and may also (or alternatively) be used with other types of rotational power tools and all single-sided and dual-sided buffing, polishing and abrasive (e.g., metal, stone, ceramic, fiber, sand, nylon, polypropylene, etc.) pads, including brush pad assemblies, generally known to those skilled in the art.

Those skilled in the art will understand that buffing pads are usually circular in shape and can be made of varying materials depending upon the needs of the operator and the finishing effect desired. The invention will work equally with all types of buffing pads, including those made of fibers, such as natural wool, synthetic fibers, a blend of the two, and with open or closed cell foam. It will also work with other types of pads, include nylon brush pads and other buffing, polishing, and/or abrasive (e.g., metal, stone, ceramic, fiber (woven and non-woven), sand, nylon, polypropylene, etc.) pads generally known to those skilled in the art. While embodiments of the present invention are described below in terms of a power tool and a single-sided buffing pad, it is only being described as such for the sake of brevity.

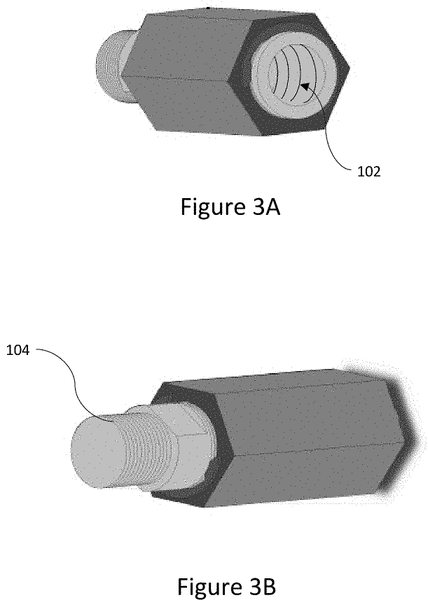

As shown in FIGS. 2 and 3A-B, an extender 10 in accordance with one embodiment of the present invention may include a shaft (e.g., constructed from plastic, wood, metal (e.g., aluminum, steel, iron, etc.), etc.), a sleeve (e.g., constructed from metal, wood, plastic (e.g., polyethylene, polypropylene, polycarbonate, etc.), etc.), and at least one retainer (120, 130) (e.g., constructed from metal, plastic, etc.). In a preferred embodiment, the retainer (120, 130) is a C-clip. With that said, other retaining rings and/or structures generally known to those skilled in the art are within the spirit and scope of the present invention. The purpose of the retainers (120, 130) is to fix the sleeve 110 (longitudinally) on the shaft 100, so that it does not interfere with rotational operation of the buffing pad and/or power tool. As shown in FIGS. 3A-B, the shaft 100 includes a first end 102 and a second end 104, where the first end 102 includes a plurality of female threads and is configured to mate with a power tool and the second end 104 includes a plurality of male threads and is configured to mate with a buffing pad. It should be appreciated that other embodiments are within the spirit and scope of the present invention. For example, the first end 102 may have male threads, a quick release connector, etc., and the second end 104 may have female threads, a quick release connector, etc., depending on the devices (e.g., buffing pad, power tool, etc.) that are to be connected to the extender and their respective connectors. Thus, an extender that includes a quick-release connector at one end and male threads at the other, male threads at both ends, female threads at both ends, etc., is within the spirit and scope of the present invention.

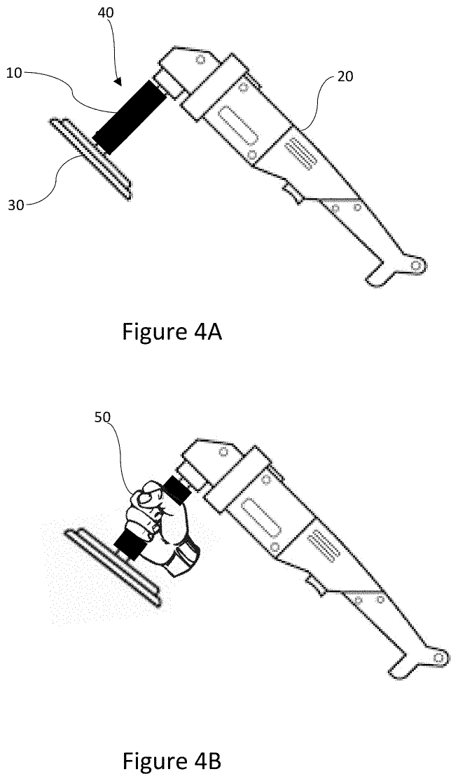

As shown in FIGS. 4A-B, the extender 10 is preferably configured to be placed between (mated with) a power tool 20 and a buffing pad 30, the assembly of which creates a buffing pad assembly 40. The extender 10 should preferably include a first portion that is rotatable, thereby allowing transfer of rotational power from the power tool 20 to the buffing pad 30, and a second portion that is non-rotatable, or can be gripped by a user's hand 50 to prevent its rotation during operation of the power tool. These portions will now be discussed in greater detail.

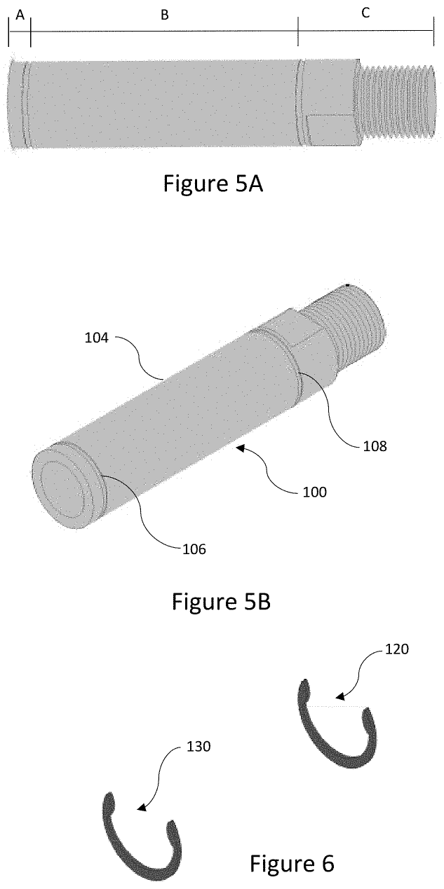

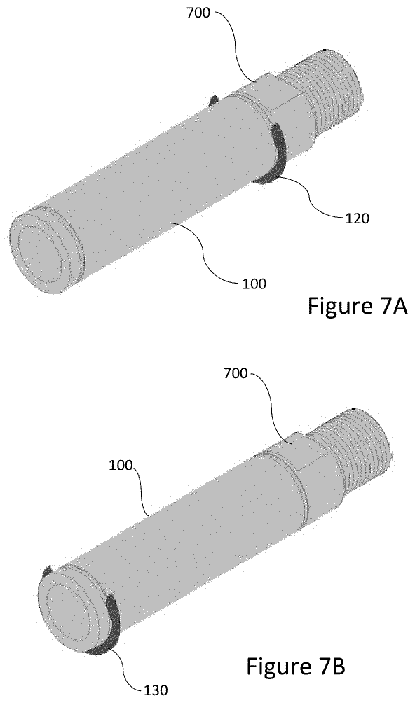

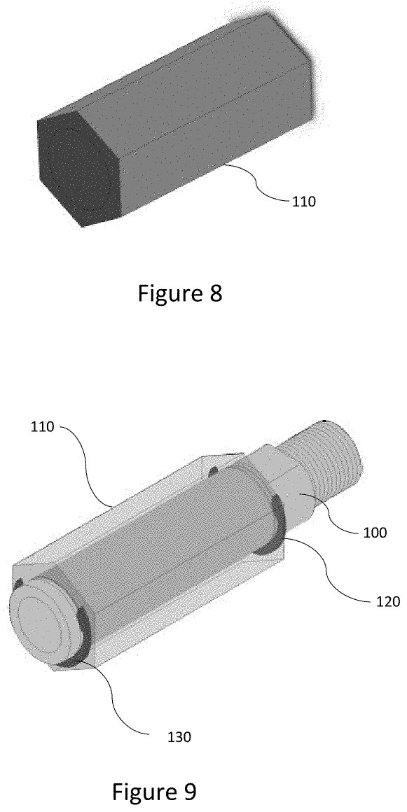

As shown in FIGS. 5A-B, the shaft 100 may include a first portion (A) near (or adjacent) the first end 102, a second portion (C) near (or adjacent) the second end 104, and a third portion (B) located therebetween, where the third portion (B) is where the sleeve will ultimately reside (at least in a preferred embodiment). This portion 104 is preferably circular (at least substantially) and is bound by two retainers. In one embodiment, the shaft 100 includes two grooves (or recesses) (106, 108) that are configured to receive corresponding retainers (e.g., C-clips) (see, e.g., FIG. 6). For example, as shown in FIG. 7A, a first C-clip 120 may be mated with (e.g., snapped over) a corresponding groove 108 on the shaft 100, or, as shown in FIG. 7B, a second C-clip 130 may be mated with (e.g., snapped over) a corresponding groove 106 on the shaft 100. The sleeve 110 (see FIG. 8) can then be slid over the first (A) or third (C) portion of the sleeve (depending on which end is open), and onto the second (B) portion, where the sleeve 110 will reside. The other C-clip can then be attached, resulting in a fully assembled extender 10 (see FIG. 9). It should be appreciated that the present invention is not limited to this embodiment (e.g., one that requires grooves, C-clips, etc.), and other embodiments are within the spirit and scope of the present invention.

In one embodiment of the present invention, the shaft further comprises opposing flat surfaces (e.g., surfaces that are parallel to one another) that can be gripped (e.g., with a wrench) when mating the extender with (or removing it from) the power tool or buffing pad. For example, while a user may be able (e.g., with their hands) to begin threading the extender onto male/female threads of the buffing pad and male/female threads of the power tool, a wrench may be need to complete the threading (e.g., to ensure snug, secure connections). In one embodiment, the flat surfaces 700 are on the second portion (B) of the shaft 100 (see FIG. 11A). A drawback of this embodiment is that the sleeve, upon final assembly, may cover (or hide) the flat surfaces 700.

For example, as shown in FIG. 11A (end view shown in FIG. 11B), the sleeve may be configured (e.g., size wise) to reside between grooves 106 and 108 and secured in place by corresponding C-clips (see, e.g., FIG. 12). This would render the flat surfaces 700 inaccessible, at least once the sleeve is secured in place. In certain situations, this may be acceptable. For example, in situations where the wrench is only used to secure the extender to the buffing pad, the sleeve can be placed over the flat surfaces 700 after the extender is connected to the buffing pad, but before it is connected to the power tool. Vice versa, this would also work in situations where the wrench is only needed to secure the extender to the power tool.

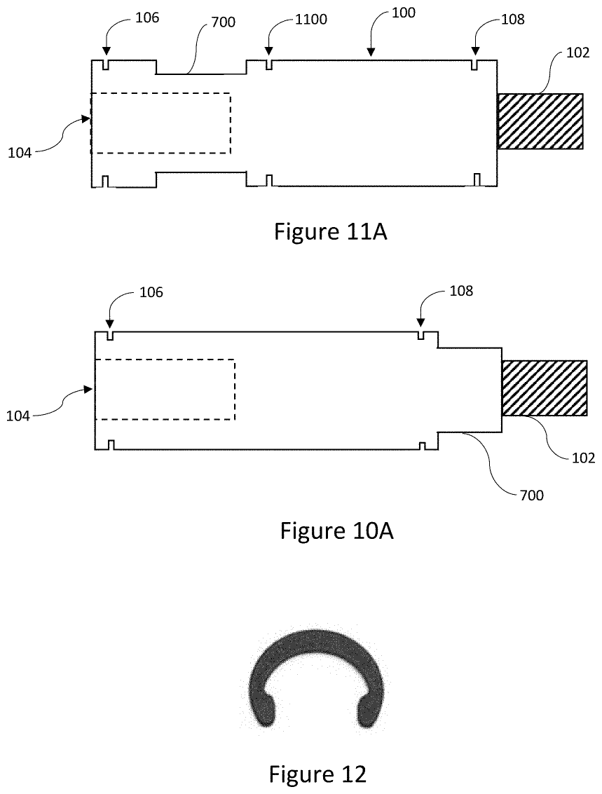

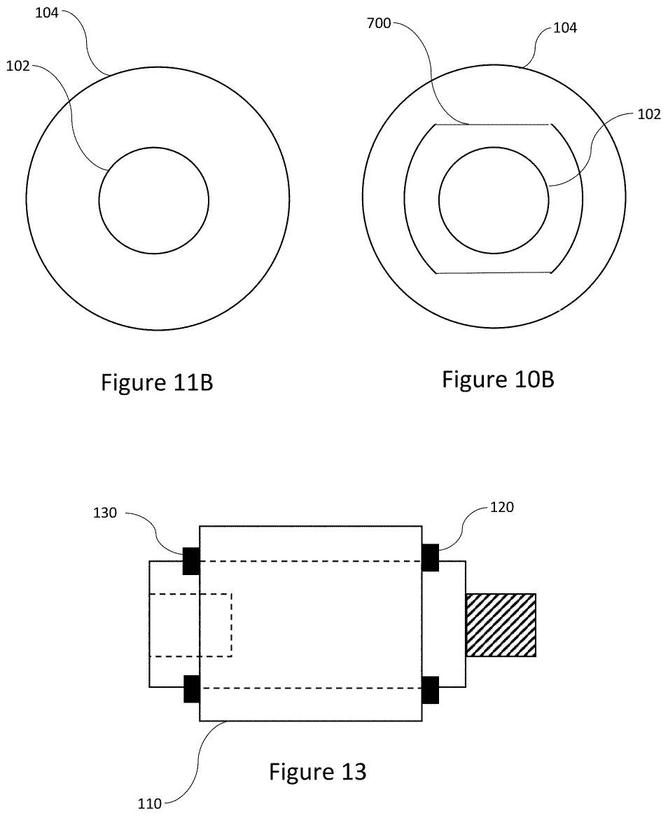

If, however, the flat surfaces 700 are required to secure the extender to both the buffing pad and the power tool, or it is desirous to fully assemble the extender before it is connected to either the buffing pad or power tool, the flat surfaces could be located on the first or third portions (A, C) (see FIG. 10A) (end view shown in FIG. 10B). Alternatively, the sleeve could be shortened, so that it is shorter than the second portion (B) of the shaft 100. For example, as shown in FIG. 11A, the sleeve could be configured to reside between grooves 108 and 1100. Depending on design constraints, alternate locations for the flat surfaces and/or sleeve are within the spirit and scope of the present invention.

As discussed above, the outer surface of the sleeve 110 is configured to be gripped by the user's hand. Thus, as shown in FIG. 13, it is preferred that its circumference (i.e., the outer circumference of 110) is greater than the circumference of the retainers (i.e., the outer circumference of 120, 130). This is because the retainers (along with the shaft) may rotate when the power tool is operated, whereas the sleeve should not (at least when it is secured by the user). Thus, to prevent the user's hand from contacting (or being injured by) the retainers 120, 130, their outer circumferences (or diameters) should preferably be less than the outer circumference (or diameter) of the sleeve 110. And in preferred embodiments, the outer circumference (or diameter) of the shaft (at least at portions A and C) should be less than the outer circumferences (or diameters) of the retainers 120, 130.

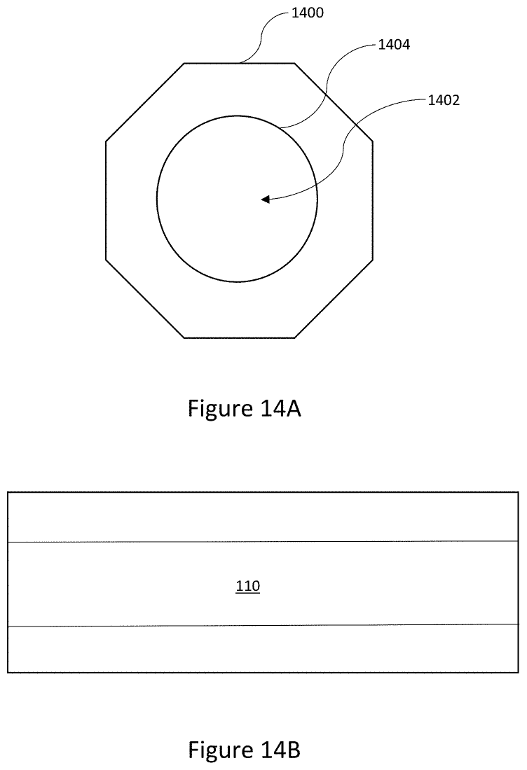

As shown in FIGS. 14A-B (A being an end view, and B being a side view), the inside (or aperture) 1402 of the sleeve 110 is preferable circular, with a diameter (or inner circumference 1404) that is slightly larger than the diameter (or outer circumference) of the shaft 100 (at least at portion B). This will allow the sleeve 110 to held by the user during rotation of the shaft 100. As such, the outer surface 1400 of the sleeve 110 should be designed so that it can easily be gripped by the user. For example, the outer surface 1400 may be non-circular, or include a plurality of flat surfaces. This should make it easier for the user to prevent rotation of the sleeve during operation of the power tool.

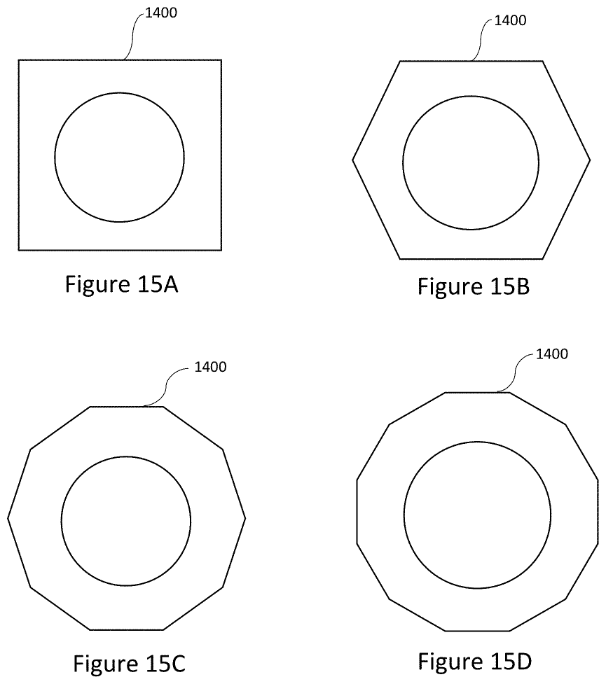

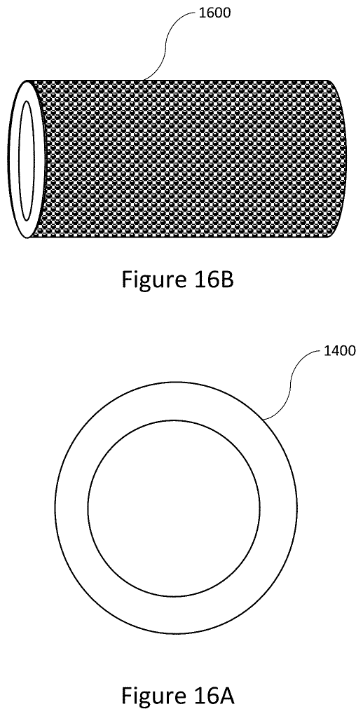

It should be appreciated that the outer surface of the sleeve is not limited to the shape depicted in FIG. 14A, and other shapes are within the spirit and scope of the present invention. For example, the outer surface could include fewer or greater flat surfaces (see, e.g., FIGS. 15A-D) or could be substantially circular (see, e.g., FIG. 16A). The outer surface may also include a texture or coating 1600 (see FIG. 16B) (e.g., a plurality of bumps, raised/recessed portions, rubber, tape, etc.) that would make it easier for the user to grip (e.g., increasing the outer surface's frictional coefficient, as opposed to the inner surface, where friction between the sleeve and the shaft should be minimized or reduced). Obviously, other methods of reducing and/or increasing friction generally known to those skilled in the art may also (or alternatively) be used and are therefore within the spirit and scope of the present invention.

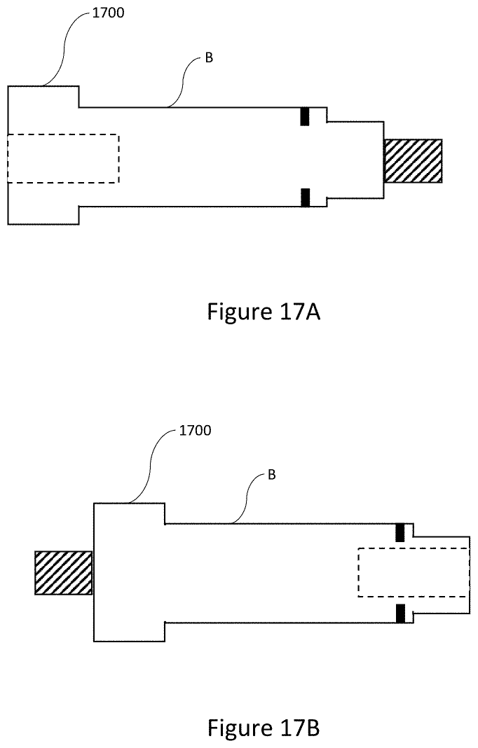

As discussed above, the present invention is not limited to the foregoing embodiments. For example, as shown in FIG. 17A, the shaft could be machined at a first end (or a second end, see FIG. 17B) to include a portion 1700 that has a greater circumference (or diameter) than the second portion (B) of the shaft, thereby creating a lip (or shoulder) that can function as a retainer for the sleeve. In other words, in accordance with this embodiment, the sleeve could be slid onto the second portion (B) of the shaft until it contacts (e.g., rests against) the lip/shoulder. A retainer (e.g., C-clip) could then be attached to the shaft, thereby securing the sleeve between the retainer (e.g., C-clip) and the lip/shoulder. Other known methods of retaining the sleeve on the shaft (e.g., other retaining rings, clamps, etc.) are within the spirit and scope of the present invention. However, it is preferred that at least one of the retainers is removable so that the sleeve can be placed on (and removed from) the shaft.

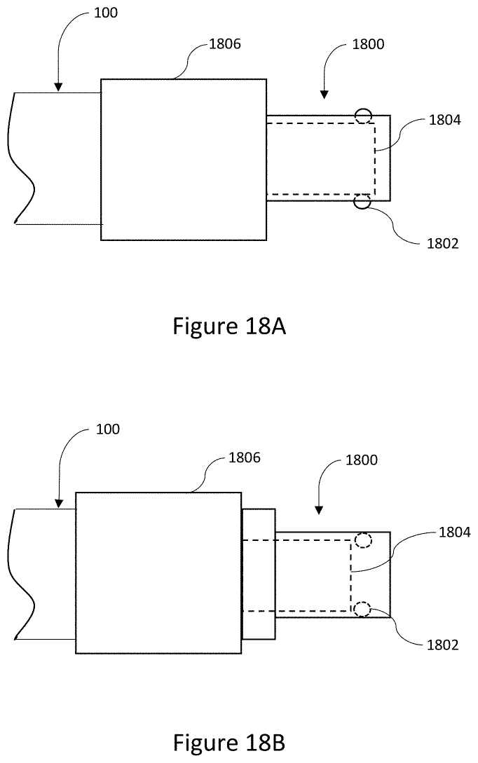

By way of another example, as discussed above, other known connection methods may be used to connect the extender to the buffing pad and/or power tool. For example, one end of the shaft may include a quick release connector 1800, like the one shown in FIGS. 18A-B. Such a connector may include a non-circular head (e.g., square, hexagonal, etc.), at least one spring-loaded ball bearing 1802, a locking means 1804 (circular or square metal portion that can move in a longitudinal direction) (e.g., within an inner cavity), and a spring-loaded sleeve 1806, where the locking means 1804 is connected to the sleeve 1806.

When the sleeve 1806 is in a forward (e.g., biased) position (see FIG. 18A), the locking means 1804 is moved forward within the cavity, thereby preventing the ball bearings 1802 from moving inward (e.g., into the cavity). Locking the ball bearings 1802 in this position should prevent removal of the extender from the buffing pad or power tool. Once the sleeve 1806, and therefore the locking means 1804, is pulled back (see FIG. 18B), the cavity is then configured to receive the ball bearings 1802, thereby allowing the extender to be removed from the buffing pad or power tool. It should be appreciated that while certain types of connectors have been described (e.g., male threads, female threads, and a quick-release connector), the present invention is not so limited, and can be configured to work with other types of connectors generally known to those skilled in the art.

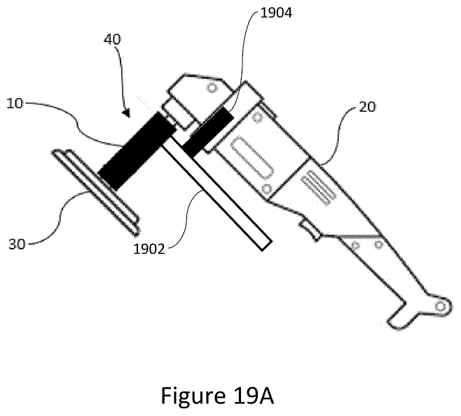

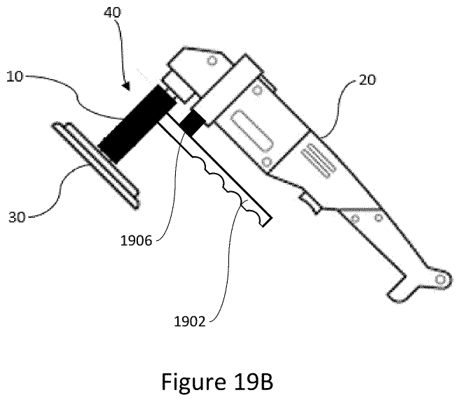

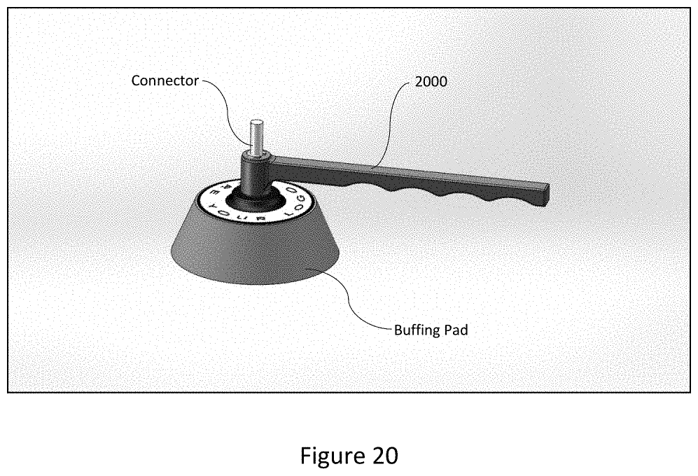

In alternate embodiments, the sleeve may include a handle (or the like) for controlling the pad and/or preventing the sleeve from rotating along with the buffing pad. By way of example, this can be seen in FIGS. 19A and B, where the extender 10 is preferably configured to be placed between (mated with) a power tool 20 and a buffing pad 30, the assembly of which creates an alternate buffing pad assembly 40. The extender 10 should preferably include a first portion that is rotatable, thereby allowing transfer of rotational power from the power tool 20 to the buffing pad 30, and a second portion that is non-rotatable, or can be gripped by a user's hand 50 to prevent its rotation during operation of the power tool. This non-rotatable portion may further include a handle 1902 extending therefrom, which may provide a way that the user can not only prevent the extender 10 (or a portion thereof) from rotating during use.

And to prevent the handle 1902 from rotating during use (e.g., when not being gripped or controlled by the user), the handle may further include a extender 1904 that will come into contact with the power tool 20 (or portion thereof), to prevent the handle 1902 from spinning (out of control, potentially damaging (or injuring) the vehicle, user, etc.). The prevention is accomplished by configuring the handle to come into contact with the power tool 20 (or portion thereof) during use. As shown in FIG. 19B, this can also be accomplished by using an extender 1906, which preferably extends from the handle 1902 perpendicularly, that is configured to connect to the power 20 (or portion thereof). The connection mechanism between the handle 1902 and the power tool 20 is open to designs that are generally known to those skilled in the art, as long as the handle 1902 is locked into place (e.g., prevented from swinging) during use of the power tool 20.

It should be appreciated that the present invention is not limited to the embodiments shown in FIGS. 19A or B and may include any situation where the handle 2000 extends, preferably perpendicularly, from the sleeve. The handle 2000 may include “scalloped” edges, making it easier to grip, and should preferably be as close to the buffing pad as possible, allowing the user to control movement and use of the buffing pad while in use.

Having thus described a preferred embodiment of an extender for a buffing pad assembly, it should be apparent to those skilled in the art that certain advantages have been achieved. It should also be appreciated that various modifications, adaptations, and alternative embodiments thereof may be made within the scope and spirit of the present invention. The invention is further defined by the following claims.

What is claimed is:

1. An apparatus for connecting a buffing pad to a power tool that can be held by a hand of a user during operation of said power tool to support said buffing pad while it is being rotated, comprising:
a metal shaft having first and second ends, one of which is configured to mate with a rotatable spindle of said power tool and the other is configure to mate with said buffing pad, said metal shaft comprising a first portion extending from said first end, a second portion extending from said second end, and a third portion that is substantially round and located between said first and second portions, wherein said second portion adjacent said third portion has a circumference that is greater than a circumference of said third portion, thereby creating a shoulder between said second and third portions;
a sleeve having a substantially circular aperture with a circumference that is greater than said circumference of said third portion and less than said circumference of said shoulder, said sleeve being configured to slide over said first portion of said metal shaft and onto said third portion, said shoulder preventing said sleeve from sliding over said second portion of said metal shaft; and
a first retainer configured to mate with said first portion of said metal shaft adjacent said third portion, thereby preventing said sleeve from sliding over said first portion of said metal shaft after said sleeve has been slid onto said third portion of said metal shaft;
wherein an outer surface of said sleeve is configured to be gripped by said hand of said user during operation of said power tool, thereby preventing said sleeve from rotating while said metal shaft is rotating within said aperture.

2. The apparatus of claim 1, further comprising a second retainer configured to mate with said second portion of said metal shaft adjacent said third portion, said second retainer creating said shoulder.

3. The apparatus of claim 2, wherein said metal shaft has a recess where said second and third portions meet, and said second retainer comprises a C-clip configured to mate with said recess.

4. The apparatus of claim 1, wherein the metal shaft has a recess where said first and third portions meet, and said first retainer comprises a C-clip configured to mate with said recess.

5. The apparatus of claim 4, further comprising a second C-clip, wherein said metal shaft has a second recess where said second and third portions meet, said second C-clip being configured to mate with said second recess.

6. The apparatus of claim 1, wherein said first end comprises male threads and said second end comprises female threads.

7. The apparatus of claim 1, wherein a circumference of said shoulder is less than an outer circumference of said sleeve.

8. The apparatus of claim 7, wherein an outer circumference of said first retainer is less than an outer circumference of said sleeve.

9. The apparatus of claim 1, wherein said metal shaft comprises a first flat surface and a second flat surface opposite of and parallel to said first flat surface, said first and second flat surfaces being configured to be gripped by a wrench during said metal shaft being attached to or removed from said buffing pad or said power tool.

10. The apparatus of claim 9, wherein said first and second flat surfaces are on said third portion of said metal shaft, and are thereby hidden by said sleeve after said apparatus has been assembled.

11. The apparatus of claim 9, wherein said first and second flat surfaces are on at least one of said first and second portions, and remain exposed after said apparatus has been assembled.

12. The apparatus of claim 1, wherein said outer surface of said sleeve is non-circular.

13. The apparatus of claim 12, wherein said outer surface of said sleeve comprises at least five flat surfaces.

14. An extender for a buffing pad, comprising:
a shaft having first and second ends, one of which is configured to mate with a power tool and the other is configure to mate with said buffing pad, said shaft comprising a first portion extending from said first end, a second portion extending from said second end, and a third portion that is located between said first and second portions, wherein an intersection between said second and third portions of said shaft comprises a lip;
a sleeve having an aperture that is configured to slide over said first portion of said shaft and onto said third portion of said shaft, said lip preventing said sleeve from sliding over said second portion of said shaft; and
a first clip configured to mate with an intersection between said first and third portion of said shaft, thereby preventing said sleeve from sliding over said first portion of said shaft after said sleeve has been slid onto said third portion of said shaft;
thereby allowing a user to prevent rotation of said sleeve while said power tool is being operated, resulting in the rotation of said shaft and said buffing pad.

15. The extender of claim 14, further comprising a second clip configured to mate with said intersection between said second and third portion, said second clip having a circumference that is greater than a circumference of said third portion, thereby defining said lip.

16. The extender of claim 15, wherein said intersection between said first and third portions comprises a first recess, said intersection between said second and third portions comprises a second recess, said first clip is configured to mate with said first recess, and said second clip is configured to mate with said second recess.

17. The extender of claim 14, wherein said first end comprises male threads and said second end comprises female threads.

18. The extender of claim 15, wherein an outer circumference of said first clip and an outer circumference of said second clip is less than an outer circumference of said sleeve.

19. The extender of claim 14, wherein said metal shaft comprises at least a pair of opposed flat surfaces configured to be gripped by a wrench, said pair of opposed flat surfaces being on one of said first and second portions of said shaft.

20. The extender of claim 14, wherein an outer surface of said sleeve is non-circular and configured to be gripped by a hand of a user.
